(19) United States
(12) Patent Application Publication
(10) Pub. No.: US 2024/0281407 A1
(43) Pub. Date: Aug. 22, 2024

(54) INFORMATION PROCESSING DEVICE, STORAGE MEDIUM STORING INFORMATION PROCESSING PROGRAM, AND INFORMATION PROCESSING METHOD

(71) Applicant: TOYOTA JIDOSHA KABUSHIKI KAISHA, Toyota-shi (JP)

(72) Inventors: Junichiro TAMAO, Tokyo (JP); Takahiro UTSUNOMIYA, Tokyo (JP); Tomoaki KARASAWA, Matsudo-shi (JP); Takumi HORIE, Chofu-shi (JP)

(73) Assignee: TOYOTA JIDOSHA KABUSHIKI KAISHA, Toyota-shi (JP)

(21) Appl. No.: 18/428,149

(22) Filed: Jan. 31, 2024

(30) Foreign Application Priority Data
Feb. 17, 2023 (JP) 2023-023614

(51) Int. Cl. G06F 16/13

(52) U.S. Cl. CPC G06F 16/13

(57) ABSTRACT

An information processing device includes processing circuitry and a storage. The storage is configured to store each of metadata and actual file data in file data in a different data block. File data that is to be newly stored in the storage is first file data. File data that has already been stored in the storage and is to be updated using the first file data is second file data. When the first file data has the same data size as the second file data, the processing circuitry is configured to update actual file data of the second file data using data to which information on an updated time is added to actual file data of the first file data, without updating metadata of the second file data.

### BACKGROUND

### 1. Field

The present disclosure relates to an information processing device, a storage medium storing an information processing program, and an information processing method.

### 2. Description of Related Art

Japanese Laid-Open Patent Publication No. 2020-197787 discloses an information processing device that includes an execution unit and a storage unit. The execution unit stores metadata including information on an updated time and a data size of data and file data including actual file data in the storage unit. The execution unit stores each of the metadata and the actual file data in a different data blocks in the storage unit.

In the information processing device disclosed in the publication, the execution unit rewrites at least two data blocks to store the metadata and the actual file data each time the file data is updated. In such an information processing device, since the minimum unit of rewriting is two data blocks, there tends to be a higher number of write operations to the storage unit. As a result, the storage unit may reach the end of its life prematurely.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An information processing device according to an aspect of the present disclosure include processing circuitry and a storage. The storage is configured to store file data including metadata and actual file data in a state in which each of the metadata and the actual file data is stored in a different data block. The metadata including information on an updated time and a data size. File data that is to be newly stored in the storage is first file data. File data that has already been stored in the storage and is to be updated using the first file data is second file data. The processing circuitry is configured to determine whether a data size of the first file data is the same as a data size of the second file data. Further, when the data size of the first file data is the same as the data size of the second file data, the processing circuitry is configured to add information on an updated time to an actual file data of the first file data, and update an actual file data of the second file data using the actual file data including the information on the updated time without updating metadata of the second file data.

A non-transitory storage medium storing an information processing program according to an aspect of the present disclosure stores an information processing program configured to be executed in an information processing device including processing circuitry and a storage. The storage is configured to store file data including metadata and actual file data in a state in which each of the metadata and the actual file data is stored in a different data block. The metadata includes information on an updated time and a data size. File data that is to be newly stored in the storage is first file data. File data that has already been stored in the storage and is to be updated using the first file data is second file data. The information processing program is configured to cause the processing circuitry to determine whether a data size of the first file data is the same as a data size of the second file data. Further, when the data size of the first file data is the same as the data size of the second file data, the information processing program is configured to cause the processing circuitry to add information on an updated time to an actual file data of the first file data, and update an actual file data of the second file data using the actual file data including the information on the updated time without updating metadata of the second file data.

An information processing method according to an aspect of the present disclosure is executed in an information processing device including processing circuitry and a storage. The storage is configured to store file data including metadata and actual file data in a state in which each of the metadata and the actual file data is stored in a different data block. The metadata includes information on an updated time and a data size. File data that is to be newly stored in the storage is first file data. File data that has already been stored in the storage and is to be updated using the first file data is second file data. The information processing method includes determining whether a data size of the first file data is the same as a data size of the second file data. When the data size of the first file data is the same as the data size of the second file data, the information processing method further includes adding information on an updated time to an actual file data of the first file data, and updating an actual file data of the second file data using the actual file data including the information on the updated time without updating metadata of the second file data.

Other features and aspects will be apparent from the following detailed description, the drawings, and the claims.

### BRIEF DESCRIPTION OF DRAWINGS

FIG. 1 is a schematic diagram showing the configuration of a vehicle.

FIG. 2 is a flowchart illustrating storage control executed by the central ECU of FIG. 1.

FIG. 3 is a flowchart illustrating read control executed by the central ECU in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the modes, devices, and/or systems described. Modifications and equivalents of the modes, devices, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Schematic Configuration of Vehicle

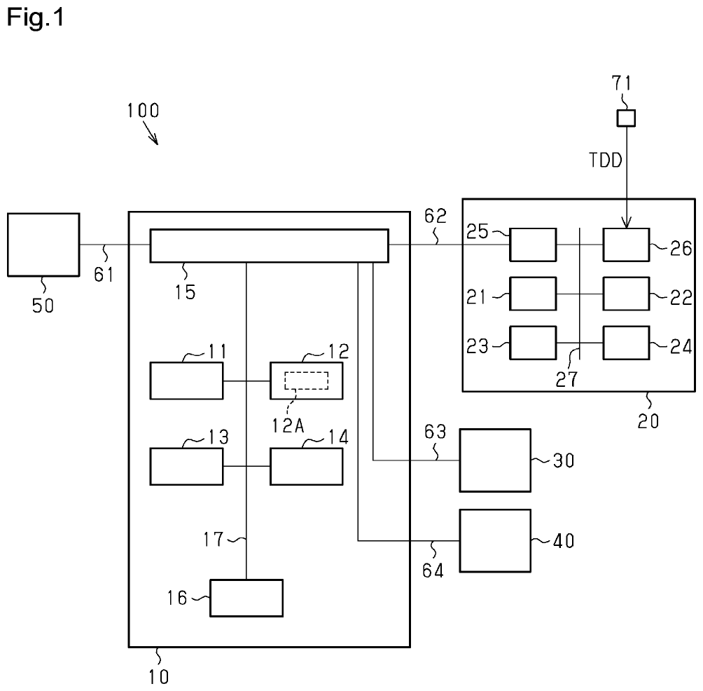

An embodiment according to the present disclosure will now be described with reference to FIGS. 1 to 3. First, the schematic structure of a vehicle 100 will be described.

As shown in FIG. 1, the vehicle 100 includes a central electronic control unit (ECU) 10, a meter ECU 20, a multimedia ECU 30, an advanced driver-assistance ECU 40, and a data communication module (DCM) 50. The vehicle 100 includes a first external bus 61, a second external bus 62, a third external bus 63, and a fourth external bus 64.

The central ECU 10 centrally controls the entire vehicle 100. The central ECU 10 includes a CPU 11, a ROM 12, a RAM 13, and a storage 14. The central ECU 10 includes a communication I/F 15, an input-output I/F 16, and an internal bus 17. The internal bus 17 connects the CPU 11, ROM 12, RAM 13, storage 14, communication I/F 15, and input-output I/F 16 such that they can communicate with each other. The ROM 12 stores various programs and various types of data in advance. The ROM 12 stores in advance an information processing program 12A as one of the programs. The RAM 13 is a volatile memory. The RAM 13 temporarily stores the programs and data. The CPU 11 uses the RAM 13 as a work area and executes various processes by reading the programs stored in the ROM 12. The CPU 11 executes various processes in the information processing method by reading the information processing program 12A. In the present embodiment, the CPU 11 is processing circuitry or an execution unit. The central ECU 10 is an information processing device.

The storage 14 is capable of storing various programs and various types of data. The storage 14 is an electrically rewritable non-volatile memory. The storage 14 is a NAND flash memory. An example of the storage 14 is an embedded Multi Media Card (eMMC). The storage 14 has a maximum number of write operations. The number of write operations for the storage 14 corresponds to the number of times that data has been written to the same memory cell. Thus, the term “write operation” includes not only writing information to an empty memory cell but also overwriting the stored content of a memory cell to which information has already been written. The maximum number of write operations on the storage 14 is the number of write operations that can be performed on one memory cell. Thus, the total capacity of the storage 14 in which data can be written including overwriting is a value obtained by multiplying the capacity of each memory cell, the number of memory cells, and the number of times data can be written in one memory cell. In the present embodiment, the storage 14 is a storage unit.

The communication I/F 15 is an interface for connecting to the meter ECU 20, the multimedia ECU 30, the advanced driver-assistance ECU 40, and the DCM 50 to each other. The communication I/F 15 also functions as an interface for connection with an engine ECU, a transmission ECU, a vehicle body ECU, and the like, which are not illustrated in the drawings. The input-output I/F 16 is an interface for connection with a sensor group and a device group included in the vehicle 100.

The DCM 50 is connected to the communication I/F 15 of the central ECU 10 via the first external bus 61. The DCM 50 is capable of wirelessly communicating with devices outside of the vehicle 100 via a wireless communication network (not shown). This allows the central ECU 10 to wirelessly communicate with the devices outside of the vehicle 100 via the first external bus 61 and the DCM 50.

The meter ECU 20 executes processes related to various meters including an odometer 71, which will be described later. The meter ECU 20 includes a CPU 21, a ROM 22, a RAM 23, and a storage 24. The meter ECU 20 includes a communication I/F 25, an input-output I/F 26, and an internal bus 27. The internal bus 27 connects the CPU 21, ROM 22, RAM 23, storage 24, communication I/F 25, and input-output I/F 26 such that they can communicate with each other. The ROM 22 stores various programs and various types of data in advance. The RAM 23 is a volatile memory. The RAM 23 temporarily stores the programs and data. The CPU 21 uses the RAM 23 as a work area and executes various processes by reading the programs stored in the ROM 22.

The storage 24 is capable of storing various programs and various types of data. The storage 24 is an electrically rewritable non-volatile memory. The storage 24 is a NOR flash memory. The storage 14, which has been described above, is a NAND flash memory. Thus, a predetermined maximum number of write operations for the storage 24, which is a NOR flash memory, is more than one order of magnitude greater than a predetermined maximum number of write operations for the storage 14.

The communication I/F 25 is an interface for connection with the central ECU 10. The communication I/F 25 is connected to the communication I/F 15 of the central ECU 10 via the second external bus 62. Thus, the meter ECU 20 can communicate with the central ECU 10. The input-output I/F 26 is an interface for connection with a sensor group and a device group included in the vehicle 100.

The multimedia ECU 30 controls a navigation device, an audio device, and the like (not shown). The multimedia ECU 30 is connected to the communication I/F 15 of the central ECU 10 via the third external bus 63. The internal configuration of the multimedia ECU 30 is substantially the same as that of the meter ECU 20 and thus will not be described.

The advanced driver-assistance ECU 40 performs various types of driver assistance by executing various applications. The applications include an application for following a vehicle ahead while maintaining a constant distance from a vehicle in front of the vehicle 100, and an application for automatically applying brakes to mitigate collision damage to the vehicle 100. The advanced driver-assistance ECU 40 is connected to the communication I/F 15 of the central ECU 10 via the fourth external bus 64. The internal configuration of the advanced driver-assistance ECU 40 is substantially the same as that of the meter ECU 20 and thus will not be described.

The vehicle 100 includes a sensor group including sensors. One of the sensors of the sensor group is an odometer 71. The odometer 71 detects a total travel distance TDD of vehicle 100. The total travel distance TDD is a total distance traveled from the time when vehicle 100 was manufactured to the current time. The odometer 71 is connected to the input-output I/F 26 of the meter ECU 20.

The CPU 11 of the central ECU 10 acquires various types of data from the meter ECU 20, the multimedia ECU 30, the advanced driver-assistance ECU 40, the DCM 50, and the like at predetermined control cycles. The data include the total travel distance TDD and the like.

### Storage Control

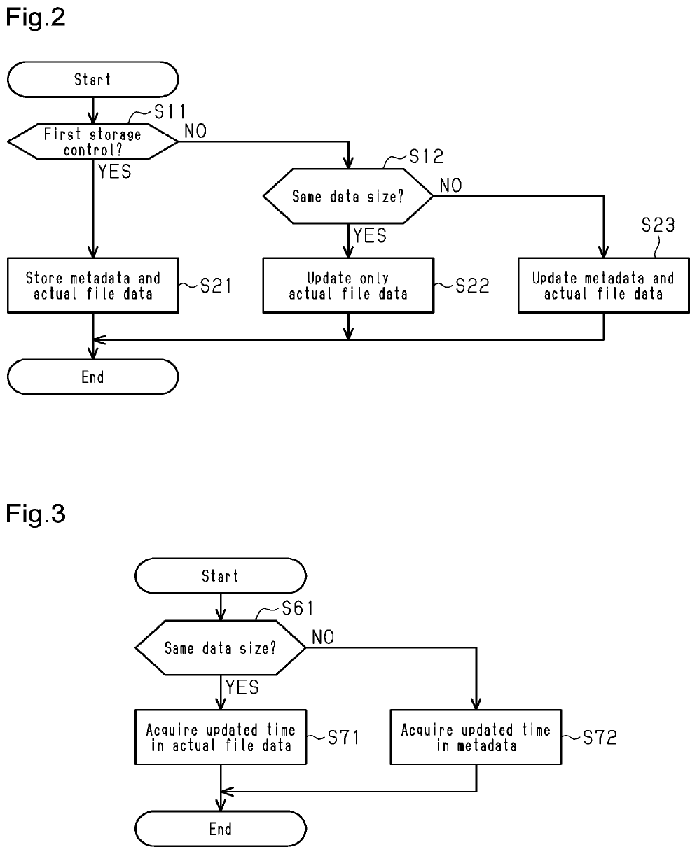

The storage control executed by the CPU 11 of the central ECU 10 will now be described with reference to FIG. 2. The CPU 11 of the central ECU 10 executes the storage control each time various types of data are acquired. The CPU 11 of the central ECU 10 executes the storage control for each type of data. In the present embodiment, the CPU 11 of the central ECU 10 executes the storage control by reading the information processing program 12A. The storage control executed when the CPU 11 acquires the total travel distance TDD via the meter ECU 20 will now be described below as an example.

As shown in FIG. 2, when starting the storage control, the CPU 11 of the central ECU 10 executes the process of step S11. In step S11, the CPU 11 determines whether the current storage control is a first storage control for the acquired data (e.g., total travel distance TDD). For example, when the total travel distance TDD is not stored in the storage 14, the CPU 11 determines that the current storage control is the first storage control for the acquired total travel distance TDD. In step S11, when the CPU 11 determines that the current storage control is the first storage control (S11: YES), the CPU 11 advances the process to step S21.

In step S21, the CPU 11 stores data related to the acquired total travel distance TDD as file data in the storage 14, with the file data divided into data blocks, each having a predetermined size. The file data includes metadata including information on the updated time and the data size, and actual file data. Thus, specifically, the CPU 11 stores the actual file data including the information on the acquired total travel distance TDD, for example, in a first data block in the storage 14. The CPU 11 stores the metadata including the information on the updated time, at which the total travel distance TDD was stored, and the information on the data size, which corresponds to the total travel distance TDD, in a second data block in the storage 14. In other words, the storage 14 stores each of the metadata and the actual file data in a different data block. After executing the process of step S21, the CPU 11 ends the current storage control.

In the above step S11, when the CPU 11 determines that the current storage control is not the first storage control, that is, a second or subsequent storage control (S11: NO), the CPU 11 advances the process to step S12.

In step S12, the CPU 11 determines whether the data size of the file data of the acquired total travel distance TDD is the same as the data size of the file data of the total travel distance TDD that has already been stored in the storage 14. In other words, the process of step S12 determines whether the data size of first file data, which is to be newly stored in the storage unit, is the same as the data size of second file data, which has already been stored in the storage unit and is to be updated using the first file data. For example, when the absolute value of the difference between the data size of the first file data and the data size of the second file data is less than or equal to a threshold value, the CPU 11 determines that the data size of the first file data is the same as the data size of the second file data. In step S12, when the CPU 11 determines that the data size of the first file data is the same as the data size of the second file data (S12: YES), the CPU 11 advances the process to step S22.

In step S22, the CPU 11 updates the file data of the acquired total travel distance TDD. The CPU 11 updates only the actual file data of the second file data stored in the storage 14 without updating the metadata of the second file data stored in the storage 14. Specifically, the CPU 11 adds the information on the updated time, at which the acquired total travel distance TDD was stored, to the actual file data of the first file data including the information on the acquired total travel distance TDD, and updates the actual file data of the second file data stored in the storage 14 using the actual file data including the information on the updated time. The CPU 11 adds the information on the updated time to the end of the actual file data of the first file data. After executing the process of step S22, the CPU 11 ends the current storage control.

In the above step S12, when the CPU 11 determines that the data size of the first file data is different from the data size of the second file data (S12: NO), the CPU 11 advances the process to step S23.

In step S23, the CPU 11 updates the file data of the acquired total travel distance TDD. The CPU 11 updates the metadata and the actual file data of the second file data stored in the storage 14. That is, the CPU 11 updates the actual file data of the second file data stored in the storage 14, using the actual file data of the first file data including the information on the acquired total travel distance TDD. The CPU 11 also updates the metadata of the second file data stored in the storage 14 using the metadata of the first file data. The metadata of the first file data includes the information on the updated time, at which the total travel distance TDD was stored, and the information on the data size, which corresponds to the total travel distance TDD. After executing the process of step S23, the CPU 11 ends the current storage control.

### Read Control

The read control executed by the CPU 11 of the central ECU 10 will now be described with reference to FIG. 3. The CPU 11 of the central ECU 10 executes the read control each time acquisition of various types of file data stored in the storage 14 is requested. The CPU 11 of the central ECU 10 executes the read control for each type of file data. In the present embodiment, the CPU 11 of the central ECU 10 executes the read control by reading the information processing program 12A. The read control executed when the file data of the total travel distance TDD stored in the storage 14 is acquired will now be described below as an example.

As shown in FIG. 3, when starting the read control, the CPU 11 of the central ECU 10 executes the process of step S61. In step S61, the CPU 11 determines whether the file data acquired from the storage 14 has been stored as the first file data having the same data size as the data size of the second file data. For example, when the updated time in the actual file data is later than the updated time in the metadata in the file data stored in the storage 14, the CPU 11 determines that the file acquired from the storage 14 has been stored as the first file data having the same data size as the data size of the second file data. When the CPU 11 makes an affirmative determination in step S61 (S61: YES), the CPU 11 advances the process to step S71.

In step S71, the CPU 11 accesses the actual file data of the file data stored in the storage 14 to acquire the information on the total travel distance TDD and the updated time from the actual file data. That is, the CPU 11 acquires the updated time in the actual file data as the latest updated time. The CPU 11 accesses the metadata of the file data stored in the storage 14 to acquire data size information from the metadata. After executing the process of step S71, the CPU 11 ends the current read control.

In the above step S61, when the CPU 11 determines that the acquired file data is stored as the first file data having a data size different from the data size of the second file data (S61: NO), the CPU 11 advances the process to step S72.

In step S72, the CPU 11 accesses the actual file data of the file data stored in the storage 14 to acquire information on the total travel distance TDD from the actual file data. The CPU 11 accesses the metadata of the file data stored in the storage 14 to acquire the information on the updated time and the data size from the metadata. That is, the CPU 11 acquires the updated time in the metadata as the latest updated time. After executing the process of step S72, the CPU 11 ends the current read control.

### Operation of Present Embodiment

For example, it is assumed that the CPU 11 repeatedly acquires the total travel distance TDD via the meter ECU 20 so that the CPU 11 repeatedly executes the storage control for the total travel distance TDD. For example, if the data size of the file data of the repeatedly acquired total travel distance TDD is the same, an affirmative determination is made in step S12 of the storage control, and the process is advanced to step S22. In step S22, when the file data of the acquired total travel distance TDD is updated, only the actual file data stored in the storage 14 is updated, without updating the metadata stored in the storage 14. Specifically, the actual file data stored in the storage 14 is updated using the actual file data including the information on the acquired total travel distance TDD and the information on the updated time, at which the total travel distance TDD was stored.

### Advantages of Present Embodiment

(1) According to the present embodiment, when it is determined in step S12 of the storage control that the data size of the first file data is the same as the data size of the second file data, only the actual file data of the second file data stored in the storage 14 is updated in step S22. Thus, the minimum unit of the data block of the storage 14 to be rewritten in accordance with the update of the file data is one. This reduces the number of rewriting operations for the data block of the storage 14, thereby preventing the storage 14 from reaching the end of its lifetime prematurely. Moreover, the information on the updated time is included in the actual file data newly stored in the storage 14. Thus, the information on the updated time is acquired from the actual file data newly stored in the storage 14 by the read control.

(2) When the actual file data of the second file data is updated in the step S22, the CPU 11 adds the information on the updated time to the end of the actual file data of the first file data. Thus, the address of data other than the information on the updated time, for example, the address of the total travel distance TDD, in the actual file data of the first file data newly stored in the storage 14 does not change depending on whether the information on the updated time is added. This eliminates or minimizes the need to change addressing in order to read the actual file data newly stored in the storage 14.

(3) In the storage control, for example, when the data sizes of the file data of the repeatedly acquired total travel distances TDD are different from each other, a negative determination is made in step S12 of the storage control, and the process is advanced to step S23. In step S23, the CPU 11 updates the metadata and the actual file data stored in the storage 14 when updating the file data of the total travel distance TDD. Thus, the information on the updated time and the information on the data size information included in the metadata are updated. This allows the information on the updated time and the data size to be acquired from the metadata newly stored in the storage 14 by the read control.

### Modifications

The present embodiment may be modified as follows. The present embodiment and the following modifications can be combined as long as they remain technically consistent with each other.

In the above embodiment, the content of the storage control may be changed.

For example, in step S22, the method of updating the file data may be changed. For example, when only the actual file data is updated without updating the metadata of the second file data stored in the storage 14, the CPU 11 may add the information on the updated time to the beginning of the actual file data of the first file data.

For example, in step S23, the method of updating the file data may be changed. For example, in the same manner as step S22, the CPU 11 may update only the actual file data stored in the storage 14 without updating the metadata stored in the storage 14 when updating the file data of the acquired total travel distance TDD. Even in this case, in the read control, the CPU 11 can acquire the information on the total travel distance TDD and the updated time from the actual file data by accessing the actual file data of the file data newly stored in the storage 14. Further, the CPU 11 can acquire the data size of the file data by analyzing the file data acquired as described above.

In the above embodiment, the configuration of the vehicle 100 may be changed.

For example, the information processing device is not limited to the central ECU 10. For example, instead of the central ECU 10, the CPU 21 of the meter ECU 20 may execute various processes in the information processing method by executing the information processing program 12A stored in the ROM 22. That is, at least one of the central ECU 10, the meter ECU 20, the multimedia ECU 30, the advanced driver-assistance ECU 40, and the like can be employed as the information processing device.

For example, each of the execution unit and the storage unit may be located in a different ECU. For example, the CPU 11 of the central ECU 10 may be the execution unit, and the storage 24 of the meter ECU 20 may be the storage unit. In this case, the information processing device includes the central ECU 10 and the meter ECU 20.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently. and/or replaced or supplemented by other components or their equivalents. The scope of the disclosure is not defined by the detailed description, but by the claims and their equivalents. All variations within the scope of the claims and their equivalents are included in the disclosure.

1. An information processing device, comprising:
processing circuitry; and
a storage, wherein
the storage is configured to store file data including metadata and actual file data in a state in which each of the metadata and the actual file data is stored in a different data block, the metadata including information on an updated time and a data size,
file data that is to be newly stored in the storage is first file data, and file data that has already been stored in the storage and is to be updated using the first file data is second file data, and
the processing circuitry is configured to:
determine whether a data size of the first file data is the same as a data size of the second file data; and
when the data size of the first file data is the same as the data size of the second file data, add information on an updated time to an actual file data of the first file data, and update an actual file data of the second file data using the actual file data including the information on the updated time without updating metadata of the second file data.

2. The information processing device according to claim 1, wherein
the processing circuitry is configured to add the information on the updated time to an end of the actual file data of the first file data.

3. The information processing device according to claim 1, wherein
the processing circuitry is configured to update the metadata and the actual file data of the second file data using the metadata and the actual file data of the first file data when the data size of the first file data is different from the data size of the second file data.

4. A non-transitory storage medium storing an information processing program configured to be executed in an information processing device including processing circuitry and a storage, wherein
the storage is configured to store file data including metadata and actual file data in a state in which each of the metadata and the actual file data is stored in a different data block, the metadata including information on an updated time and a data size,
file data that is to be newly stored in the storage is first file data, and file data that has already been stored in the storage and is to be updated using the first file data is second file data, and
the information processing program is configured to cause the processing circuitry to:
determine whether a data size of the first file data is the same as a data size of the second file data; and
when the data size of the first file data is the same as the data size of the second file data, add information on an updated time to an actual file data of the first file data, and update an actual file data of the second file data using the actual file data including the information on the updated time without updating metadata of the second file data.

5. An information processing method executed in an information processing device including processing circuitry and a storage, wherein
the storage is configured to store file data including metadata and actual file data in a state in which each of the metadata and the actual file data is stored in a different data block, the metadata including information on an updated time and a data size,
file data that is to be newly stored in the storage is first file data, and file data that has already been stored in the storage and is to be updated using the first file data is second file data, and
the information processing method comprises:
determining whether a data size of the first file data is the same as a data size of the second file data; and
when the data size of the first file data is the same as the data size of the second file data, adding information on an updated time to an actual file data of the first file data, and updating an actual file data of the second file data using the actual file data including the information on the updated time without updating metadata of the second file data.
